(19) United States
(12) Patent Application Publication
(10) Pub. No.: US 2019/0210074 A1
(43) Pub. Date: Jul. 11, 2019

(54) PRESSURE WASHER AND METHOD OF OPERATING A PRESSURE WASHER WITH ELECTRONIC PRESSURE/FLOW CONTROL AND DISPLAY

(71) Applicant: Sunrise Global Marketing, Mooresville, NC (US)

(72) Inventor: Yin CHEN, Shanghai (CN)

(73) Assignee: Sunrise Global Marketing, Mooresville, NC (US)

(21) Appl. No.: 16/326,854

(22) PCT Filed: Sep. 7, 2017
(86) PCT No.: PCT/US17/50422

§ 371 Date: Feb. 20, 2019

Related U.S. Application Data
(60) Provisional application No. 62/384,531, filed on Sep. 7, 2016.

(51) Int. Cl. B08B 3/02; B05B 9/01; B05B 7/24

(52) U.S. Cl. CPC B08B 3/026; B05B 9/01; B08B 2203/027; B08B 2203/0223; B05B 7/2464

(57) ABSTRACT

A pressure washer (10) includes a pump (12), a hose (14), a wand (16) and first and second nozzle configurations (18a, 18b). A control (30) is electrically coupled to an electric motor (20) for running the pump (12). The control (30) senses the level of electric current being drawn by the electric motor (20) during operation and, in response, automatically adjusts the level of electric current drawn by the electric motor (20) between at least a first level and a second, different level. This changes the rate of rotation of the motor output (20a) depending on whether the first nozzle configuration (18a) or the second nozzle configuration (18b) is coupled in fluid communication with the wand (16). An electronic display (40) is coupled to the control (30). The control (30) senses the output pressure from the pump (12) and provides an electronic indication to the user on the display (40) to show at least a relative pressure condition.

### CROSS-REFERENCE TO RELATED APPLICATION

The application claims priority to U.S. Provisional Application Ser. No. 62/384,531, filed Sep. 7, 2016 (pending), the disclosure of which is hereby incorporated by reference herein.

### TECHNICAL FIELD

The invention generally relates to pressure washers and, particularly, manners of controlling and indicating pressure and/or flow output for users.

### BACKGROUND

Pressure washers are useful for many applications involving the cleaning of various surfaces, including concrete and other hard surfaces such as outdoor patios, driveways and walkways. Other items that benefit from pressure washing include more delicate or easily damaged surfaces such as siding, fences, and automobiles. It is generally up to the user to determine how much or how little fluid force to apply to a particular surface in order to obtain optimal cleaning with little or no damage to the target surface. If too little force is applied, then the desired cleaning effect will not be achieved or may take too long to achieve. Conversely, if too much force is applied, then damage can occur to the target surface. Therefore, it would be desirable to provide pressure washing apparatus and methods to assist users in obtaining optimal cleaning and little to no resulting surface damage or other negative results.

### SUMMARY

In one general and illustrative embodiment, a pressure washer is provided and includes a pump with a pump inlet for receiving liquid to be pressurized, and a pump outlet. A hose includes a hose inlet configured to be coupled in fluid communication with the pump outlet, and a hose outlet. A wand includes a wand inlet configured to be coupled in fluid communication with the hose outlet, and a wand outlet. The pressure washer further includes a first nozzle configuration and a second nozzle configuration, wherein each of the first and second nozzle configurations is selectively capable of being coupled in fluid communication with the wand outlet. The first and second nozzle configurations have respective first and second through bores. The first through bore is configured to provide a different flow rate than the second through bore. An electric motor includes a rotatable output coupled with the pump for operating the pump to pressurize liquid and direct the liquid through the hose, the wand and a selected one of the first or second nozzle configurations coupled in fluid communication with the wand. A control is electrically coupled to the electric motor. The control senses an electric profile or load of the motor during use. For example, the level of electric current being drawn by the electric motor during operation or use of the pressure washer may be sensed. In response, the control automatically adjusts the level of electric current drawn by the electric motor between at least a first level and a second, different level. This changes the rate of rotation of the rotatable output depending on whether the first nozzle configuration or the second nozzle configuration is coupled in fluid communication with the wand.

The electric motor may further comprise a brushless DC motor in various embodiments. The control may increase the level of electric current drawn by the brushless DC motor to thereby increase the rate of rotation of the rotatable output as a function of an increase in flow rate. The opposite may occur instead, depending on whether the user is changing the nozzle configuration from, for example, a high flow rate/low pressure nozzle configuration to a low flow rate/high pressure nozzle configuration or vice versa. The control can further comprise a rev limiter for limiting the rate of rotation of the motor output. This is useful, for example, for preventing the adjustment in motor RPM from resulting in an excessive rate of rotation and possible motor burn-out. The control preferably holds the level of electric current drawn by the brushless DC motor substantially constant. The substantially constant level of current may be, for example, 15 Amps unless it is limited to a lower level due to the rev limiter intervening to limit the motor RPM. The first and second nozzle configurations may further respectively comprise first and second nozzles independently attachable to the wand. Alternatively, the first and second nozzle configurations may further respectively comprise first and second nozzle configurations of an adjustable nozzle.

In another illustrative aspect, a method of operating a pressure washer comprises fluidly coupling one of a first nozzle configuration or a second nozzle configuration in communication with the wand. The first and second nozzle configurations have respective first and second through bores configured to provide different flow rates therethrough. Electric current is supplied to the electric motor to rotate the rotatable output and pump the liquid through the hose, the wand and the first nozzle configuration coupled to the wand. Then, the second nozzle configuration is fluidly coupled to the wand. A control electrically coupled to the electric motor senses that the second nozzle configuration is fluidly coupled to the wand. For example, the control can accomplish this by sensing the change in electric profile or load of the motor. The control adjusts the level of electric current drawn by the electric motor to a level different from the level of current drawn by the electric motor when the first nozzle configuration was fluidly coupled to the wand to thereby change the rate of rotation of the rotatable output and the flow rate through the second nozzle configuration when the second nozzle configuration is fluidly coupled to the wand.

The electric motor may further comprise a brushless DC motor, and adjusting the level of current further comprises increasing the level of electric current drawn by the brushless DC motor to thereby increase the rate of rotation of the rotatable output as a function of an increase in flow rate. The invention may include limiting the rate of rotation of the motor output to a maximum rate. Adjusting the level of current may further comprise holding the level of electric current drawn by the brushless DC motor substantially constant when the respective first and second nozzle configurations are fluidly coupled to the wand. The substantially constant level of current may be 15 Amps. The first and second nozzle configurations may further respectively comprise first and second nozzles and fluidly coupling the second nozzle configuration may then further comprise removing the first nozzle from the wand and coupling the second nozzle to the wand. Alternatively, the first and second nozzle configurations may further respectively comprise first and second adjusted positions of an adjustable nozzle, and fluidly coupling the second nozzle configuration may then further comprise changing the adjustable nozzle from the first adjusted position to the second adjusted position.

In another general and illustrative embodiment, a pressure washer is provided and includes a hose and a wand as generally described above. A nozzle is coupled in fluid communication with the wand outlet for directing the liquid at an output pressure. A gasoline or electric powered motor is coupled with the pump for operating the pump to pressurize liquid and direct the pressurized liquid through the hose, the wand and the nozzle coupled to the wand. An electronic display and a control are electrically coupled to each other. The control senses at least a relative level of output pressure from a nozzle coupled to the wand, and causes the electronic display to indicate to a user the level of the output pressure at least on a relative basis. The electric motor may further comprise a brushless DC motor.

The electronic display may include multiple visual indicators, and the control activates one of the multiple visual indicators to communicate a relative level of the output pressure to the user. The multiple visual indicators may comprise icons, such as icons which may be selectively illuminated by the control depending on the sensed output pressure. Each icon may represent a different use or application of the pressure washer.

The invention also provides a method of operating a pressure washer, such as generally described above, and the method includes sensing the output pressure with a control and displaying an indication of the output pressure, at least on a relative basis, by electrically communicating the sensed output pressure from the control to an electronic display. The electronic display may include multiple visual indicators, and the method may further comprise activating one of the multiple visual indicators to communicate at least a relative level of the output pressure to the user. Activating one of the multiple visual indicators may further comprise activating one of multiple icons each representing a different use or application of the pressure washer.

Various additional objectives, advantages, and features of the invention will be appreciated from a review of the following detailed description of the illustrative embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view illustrating one exemplary embodiment of a pressure washer constructed in accordance with the invention.

FIG. 2 is a block diagram illustrating the pressure washer of FIG. 1

FIG. 3 is a schematic diagram showing multiple nozzle configurations usable with the pressure washer of FIG. 1.

### DETAILED DESCRIPTION

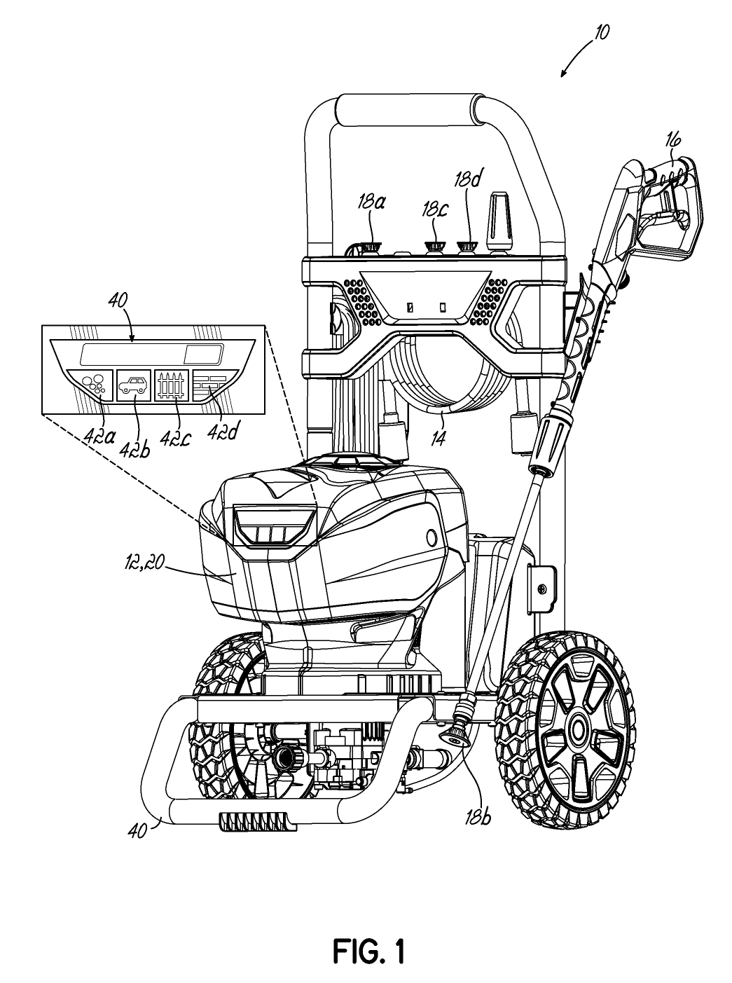

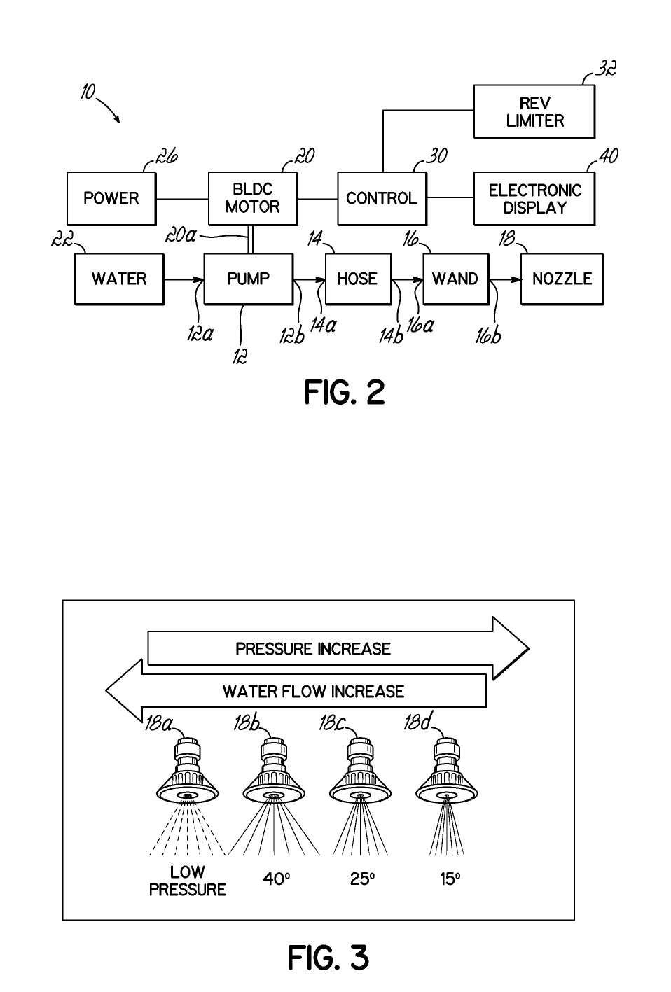

Referring generally to FIGS. 1, 2 and 3, in one illustrative embodiment, a pressure washer 10 is provided and includes a pump 12 with a pump inlet 12a for receiving liquid to be pressurized, and a pump outlet 12b. A hose 14 includes a hose inlet 14a configured to be coupled in fluid communication with the pump outlet 12b, and a hose outlet 14b. A wand 16 includes a wand inlet 16a configured to be coupled in fluid communication with the hose outlet 14b, and a wand outlet 16b. The pressure washer 10 further includes at least one nozzle 18 (FIG. 2). Multiple nozzles 18a, 18b, 18c, 18d are shown in FIG. 3. These may be referred to as “nozzles” or “nozzle configurations” (as further discussed below). Although four nozzle configurations 18a-d are shown, it will be appreciated that two or more may be provided depending on user needs or preferences. The nozzle 18 may comprise a single, adjustable nozzle configurable between different flow/pressure profiles and spray patterns 18a-d (FIG. 3) or at least two separate and distinct nozzles 18a-d, each having a different spray flow/pressure profile and spray pattern. As shown in FIG. 3, the nozzle(s) 18a-d are configured to discharge individually unique spray patterns, such as shown in FIG. 3. Individual nozzles 18a-d may be permanently designed to emit different spray patterns and attached to the wand 16 depending on the application needs (i.e., a hard surface such as concrete or a more delicate surface such as wood). Alternatively, in a known manner, a single adjustable nozzle 18 may be adjusted between two or more positions or throughbore configurations to discharge such varying spray patterns (FIG. 3) having different flow rate/pressure outputs. In either manner, at least a first nozzle configuration (e.g., 18a) and a second nozzle configuration (e.g., 18b) are provided for addressing different jobs or applications of the pressure washer 10. Each of the first and second nozzle configurations 18a, 18b is selectively capable of being coupled in fluid communication with the wand outlet 16b. The first and second nozzle configurations 18a, 18b have respective first and second through bores. The first through bore is configured to provide a different flow rate than the second through bore. The effect is shown in the example of FIG. 3 which diagrammatically shows four nozzles 18a-d having different applications ranging from delicate application of soap and water to high power, hard surface cleaning.

An electric motor 20 (FIG. 2) receives power from an AC or DC power supply 22 and includes a rotatable output 20a coupled with the pump 12 for operating the pump 12 to pressurize liquid and direct the liquid through the hose 14, the wand 16 and a selected one of the nozzle configurations such as nozzle configurations 18a-d coupled in fluid communication with the wand 16. The pump 12 receives water from a source 24 such as a garden hose coupled to a spigot (not shown). A control 30 is electrically coupled to the electric motor 20. The control 30 senses the level of electric current being drawn by the electric motor 20 during operation or use of the pressure washer 10 and, in response, automatically adjusts the level of electric current drawn by the electric motor 20 between at least a first level and a second, different level. This changes the rate of rotation of the rotatable output 20a depending on whether the first nozzle configuration 18a or the second nozzle configuration 18b is coupled in fluid communication with the wand 16. As mentioned, the first and second nozzle “configurations” may or may not be derived from the same nozzle structure. The maximum pressure developed by the pressure washer may be, for example, 2200 psi or higher and this maximum could be lower depending on the application or intended use.

The electric motor 20 may further comprise a brushless DC motor in various embodiments. The control 30 may increase the level of electric current drawn by the brushless DC motor 20 to thereby increase the rate of rotation of the rotatable output 20a as a function of an increase in flow rate and attendant decrease in pressure at the nozzle 18. The opposite may occur instead, depending on whether the user is changing the nozzle configuration from, for example, a high flow rate/low pressure nozzle configuration to a low flow rate/high pressure nozzle configuration or vice versa. Generally, the goal is to increase motor RPMs in order to provide constant reliable pressure, especially when using lower pressure/higher flow nozzle configurations. The control 30 can further comprise a rev limiter 32 for limiting the rate of rotation of the motor output 20a. This is useful, for example, for preventing an increase in motor RPM from resulting in an excessive rate of rotation and possible motor burn-out.

The control 30 preferably holds the level of electric current drawn by the brushless DC motor 20 substantially constant. In the illustrative embodiment, the substantially constant level of current is 15 Amps unless it is limited to a lower level due, for example, to the rev limiter 32 intervening to limit the motor RPM. The first and second nozzle configurations (e.g., 18a, 18b) may further respectively comprise first and second nozzles 18 independently attachable to the wand. As mentioned, the first and second nozzle configurations may instead respectively comprise first and second nozzle configurations of an adjustable nozzle structure. For example, an adjustable nozzle 18 may be rotatable between at least two positions that change the throughbore configuration between a relatively high flow rate/low pressure configuration and a lower flow rate/higher pressure configuration (see FIG. 3). Such adjustable nozzle constructions are known.

A method of operating the pressure washer 10 comprises fluidly coupling one of a first nozzle configuration (e.g., 18a) or a second nozzle configuration (e.g., 18b) in communication with the wand 16. The first and second nozzle configurations 18a, 18b have respective first and second through bores configured to provide different flow rate and pressure profiles therethrough and different spray patterns depending on the job. Electric current is supplied to the electric motor 20 to rotate the rotatable output 20a and pump the liquid through the hose 14, the wand 16 and the first nozzle configuration 18a fluidly coupled to the wand 16. Then, the second nozzle configuration 18b is fluidly coupled to the wand 16. A control 30 electrically coupled to the electric motor 20 senses that the second nozzle configuration 18b is fluidly coupled to the wand 16. This is accomplished as the control 30 senses the electric profile or load on the motor 20. The control 30 adjusts the level of electric current drawn by the electric motor 20 to a level different from the level of current drawn by the electric motor 20 when the first nozzle configuration 18a was fluidly coupled to the wand 16 to thereby change the rate of rotation of the rotatable output 20a and the flow rate through the second nozzle configuration 18b when the second nozzle configuration 18b is fluidly coupled to the wand 16.

The electric motor 20 may further comprise a brushless DC motor, and adjusting the level of current further comprises increasing the level of electric current drawn by the brushless DC motor 20 to thereby increase the rate of rotation of the rotatable output 20a as a function of an increase in flow rate. The control 30 can more specifically comprise a programmable circuit board or any other suitable programmable device, including components that those of ordinary skill would use to carry out the methodology described herein. As an example, if the control 30 senses the electric current to be at 12 Amps, it will increase the level of current to be 15 Amps thereby increasing motor RPMs. However, if a maximum RPM for the motor 20 is reached prior to the electric current load on the motor 20 reaching the intended level of 15 Amps, then the rev limiter 32 will intervene and the control 30 will cap the maximum amperage level to that equating to or otherwise associated with the maximum RPM level. In this manner, the method includes limiting the rate of rotation of the motor output 20a to a maximum rate using the rev limiter 32. Adjusting the level of current may further comprise holding the level of electric current drawn by the brushless DC motor 20 substantially constant when the respective first and second nozzle configurations 18a, 18b are fluidly coupled to the wand 16. The substantially constant level of current may be 15 Amps. The first and second nozzle configurations 18a, 18b (by way of example only) may further respectively comprise first and second nozzles 18a, 18b and fluidly coupling the second nozzle configuration 18b may then further comprise removing the first nozzle 18a from the wand 16 and coupling the second nozzle 18b to the wand 16. Alternatively, the first and second nozzle configurations 18a, 18b may further respectively comprise first and second adjusted positions of an adjustable nozzle 18 (e.g., see FIG. 2), and fluidly coupling the second nozzle configuration 18b may then further comprise changing the adjustable nozzle 18 from the first adjusted position to the second adjusted position to change the spray pattern.

In another general aspect, an electronic display 40 is electrically coupled to the control 30 and electrically coupled to the electric motor 20 as shown in FIG. 3. The control 30 causes the electronic display 32 to indicate to a user the level of the output pressure at least on a relative basis. For example, the control 30 infers the relative pressure/flow condition by sensing the amperage drawn on the motor 20. If the amperage is relatively high, then this corresponds to a high pressure condition such as when nozzle 18d should be in use. When the control 30 senses a low amperage condition, this will indicate that a lower pressure nozzle (e.g., 18a) should be in use.

The electronic display 40 includes multiple visual indicators such as 42a, 42b, 42c, 42d, and the control 30 activates one of the multiple visual indicators 42a, 42b, 42c, 42d to communicate a relative level of the output pressure to the user. The multiple visual indicators 42a, 42b, 42c, 42d may comprise LED activatable icons representing different uses of the pressure washer 10. When a particular LED illuminated icon 42a-d is lit or activated, the user will thereby be notified to use the pressure washer on that type of surface or application for optimal cleaning and minimal damage potential.

The invention also provides a method of operating a pressure washer 10, such as generally described above, and the method includes sensing the output pressure with a control 30 electrically connected to the electric motor 20, and displaying an indication of the output pressure, at least on a relative basis, by electrically communicating the sensed output pressure from the control 30 to an electronic display 40. The electronic display 40 may include multiple visual indicators 42a-d, and the method may further comprise activating one of the multiple visual indicators 42a-d to communicate at least a relative level of the output pressure to the user. Activating one of the multiple visual indicators 42a-d may further comprise activating one of multiple icons each representing a different use of the pressure washer. In this example, the LED illuminated icons 42a-42d respectively correspond to the use of nozzles 18a-18d. Use of nozzle 18a will result in illumination of icon 42a; use of nozzle 18b will result in illumination of icon 42b; use of nozzle 18c will result in illumination of icon 42c; and use of nozzle 18d will result in illumination of icon 42d. It will be appreciated that this aspect of the invention, as well as others, may or may not be used together with the automated electric profile adjustment discussed above. In addition, the sensing and display of pressure output may be adapted for use on gasoline powered pressure washers in addition to the electric pressure washer applications discussed above. In this regard, a gasoline powered pressure washer may include a suitable battery for powering a control, and the control may include a pressure sensor that performs the pressure sensing function. In response to the sensed pressure, an electronic display which is electrically coupled to the control would indicate at least a relative pressure to the user as described above, such as by activating a suitable icon associated with that pressure level. Alternatively, in any of the embodiments including an electronic display, the display could indicate actual pressure to the user for purposes of greater accuracy. For most users, it will be sufficient to activate an icon that indicates symbolically the liquid pressure being output by the pressure washer and thereby inform the user of the appropriate application for that pressure.

While the present invention has been illustrated by a description of various preferred embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims.

1. A pressure washer, comprising:
a pump including a pump inlet for receiving liquid to be pressurized and a pump outlet;
a hose including a hose inlet configured to be coupled in fluid communication with the pump outlet, and a hose outlet;
a wand including a wand inlet configured to be coupled in fluid communication with the hose outlet, and a wand outlet;
a first nozzle configuration and a second nozzle configuration, wherein each of the first and second nozzle configurations is selectively capable of being coupled in fluid communication with the wand outlet, and the first and second nozzle configurations have respective first and second through bores, the first through bore configured to provide a different flow rate than the second through bore;
an electric motor including a rotatable output coupled with the pump for operating the pump to pressurize liquid and direct the liquid through the hose, the wand and a selected one of the first or second nozzle configurations coupled in fluid communication with the wand; and
a control electrically coupled to the electric motor, wherein the control senses an electric profile of the electric motor during operation and, in response, automatically adjusts the level of electric current drawn by the electric motor between at least a first level and a second, different level to thereby change the rate of rotation of the rotatable output depending on whether the first nozzle configuration or the second nozzle configuration is coupled in fluid communication with the wand.

2. The pressure washer of claim 1, wherein the electric motor further comprises a brushless DC motor.

3. The pressure washer of claim 2, wherein the control increases the level of electric current drawn by the brushless DC motor to thereby increase the rate of rotation of the rotatable output as a function of an increase in flow rate.

4. The pressure washer of claim 3, wherein the control further comprises a rev limiter for limiting the rate of rotation of the motor output.

5. The pressure washer of claim 3, wherein the control holds the level of electric current drawn by the brushless DC motor substantially constant.

6. The pressure washer of claim 5, wherein the substantially constant level of current is 15 Amps.

7. The pressure washer of claim 1, wherein the control further comprises a rev limiter for limiting the rate of rotation of the motor output.

8. The pressure washer of claim 1 , wherein the first and second nozzle configurations further respectively comprise first and second nozzles independently attachable to the wand.

9. The pressure washer of claim 1, wherein the first and second nozzle configurations further respectively comprise first and second nozzle configurations of an adjustable nozzle.

10. A method of operating a pressure washer including a pump operated by an electric motor to direct pressurized liquid into a hose fluidly coupled to a wand, the method comprising;
fluidly coupling one of a first nozzle configuration or a second nozzle configuration in communication with the wand, wherein the first and second nozzle configurations have respective first and second through bores configured to provide different flow rates therethrough;
supplying electric current to the electric motor to rotate the rotatable output and pump the liquid through the hose, the wand and the first nozzle configuration coupled to the wand;
fluidly coupling the second nozzle configuration to the wand;
using a control electrically coupled to the electric motor to sense that the second nozzle configuration is fluidly coupled to the wand; and
adjusting the level of electric current drawn by the electric motor to a level different from the level of current drawn by the electric motor when the first nozzle configuration was fluidly coupled to the wand to thereby change the rate of rotation of the rotatable output and the flow rate through the second nozzle configuration when the second nozzle configuration is fluidly coupled to the wand.

11. The method of claim 10, wherein the electric motor further comprises a brushless DC motor, and adjusting the level of current further comprises:
increasing the level of electric current drawn by the brushless DC motor to thereby increase the rate of rotation of the rotatable output as a function of an increase in flow rate.

12. The method of claim 11 , further comprising:
limiting the rate of rotation of the motor output to a maximum rate.

13. The method of claim 10, further comprising:
limiting the rate of rotation of the motor output to a maximum rate.

14. The method of claim 10, wherein the electric motor further comprises a brushless DC motor, and adjusting the level of current further comprises:
holding the level of electric current drawn by the brushless DC motor substantially constant when the respective first and second nozzle configurations are fluidly coupled to the wand.

15. The method of claim 14, wherein the substantially constant level of current is 15 Amps.

16. The method of claim 10, wherein the first and second nozzle configurations further respectively comprise first and second nozzles and fluidly coupling the second nozzle configuration further comprises:
removing the first nozzle from the wand; and
coupling the second nozzle to the wand.

17. The method of claim 10, wherein the first and second nozzle configurations further respectively comprise first and second adjusted positions of an adjustable nozzle, and fluidly coupling the second nozzle configuration further comprises:
changing the adjustable nozzle from the first adjusted position to the second adjusted position.

18-27. (Canceled)
